(19) United States
(12) Patent Application Publication
(10) Pub. No.: US 2017/0097235 A1
(43) Pub. Date: Apr. 6, 2017

(54) Measurement Apparatus to Locate an Orientation With Respect to a Surface

(71) Applicant: Daniel Roman Prochoda, Woodland Park, CO (US)

(72) Inventor: Daniel Roman Prochoda, Woodland Park, CO (US)

(21) Appl. No.: 14/874,465

(22) Filed: Oct. 4, 2015

(51) Int. Cl. G01C 3/00

(52) U.S. Cl. CPC G01C 3/00

(57) ABSTRACT

A non-contacting measurement apparatus to measure a two or three dimensional out of plane orientation with respect to a point on a flat surface and/or a two dimensional out of plane orientation with respect to a curved surface. Various embodiments are possible with some being capable of measuring perpendicularity to the surface, closest distance to the surface, angles of incidence of a vector from the measurement apparatus to the point on the surface, and/or generating three dimensional coordinate representations of the point on the surface with respect to the measurement apparatus and/or its components. Some embodiments of the measurement apparatus allow it to obtain orientation data dynamically, allowing the measurement apparatus and/or the surface to be moving while obtaining the orientation measurements. Additionally some embodiments of the measurement apparatus are capable of guiding a user to a particular orientation through an output device, while others are capable of calculating velocity and acceleration under specific conditions.

### CROSS-REFERENCE TO RELATED APPLICATIONS

Not Applicable

### BACKGROUND OF THE INVENTION

Technical Field

The present application relates to measuring distances and angles to establish orientation of an out of plane location in regard to a flat or curved surface using an energy source and sensor such as a laser light source. Some embodiments have the capability of measuring accelerations and velocities under specific conditions.

Background

Locating an out of plane orientation with respect to a point on a flat surface is often complicated by requiring multiple measurements to locate the orientation, especially if the surface is difficult to access. Laser range finding devices have helped to alleviate these problems, but still require taking multiple measurements from one position to triangulate a location before moving to the next. Few options are available to deal with these situation, and many, such as GPS, are expensive and then do not always work in all environments such as indoors. Additionally, identifying out of plane orientations often requires either a knowledge of trigonometry and/or orientation tools that are not always simple and/or convenient to use in a field situation.

Other situations require tracking a point on a surface that is moving, or attempting to track a surface from a moving platform. These situations often require tracking devices and/or reflectors placed on the moving surface and often additional triangulation equipment staged around the scene to make tracking possible. This can be both expensive and time consuming to set up.

Additionally, other situations require orientation with respect to a point on a curved surface which adds additional complications to conventional measurement techniques requiring numerous measurements to determine curvature and or expensive equipment to conduct such measurements.

### BRIEF SUMMARY OF THE INVENTION

In some embodiments, the present disclosure provides a measurement apparatus that allows a quick identification of present orientation in regard to a point on a flat surface or with respect to a curved surface that is circular or parabolic in nature. To obtain this orientation information, the user simply points the measurement apparatus, or its distance measuring components if separately located, at the desired target point, and obtains data pertaining to orientation from the output that the measurement apparatus provides.

The measurement apparatus operates on the premise that the surface surrounding the point of interest is consistently flat and/or curved, and extends in at least one or two dimensions away from the target point of interest a sufficient distance such that a plurality of measurements to this surface will suffice in being able to triangulate the position of the measurement apparatus. The measurement apparatus accomplishes this by obtaining a set of distance measurements to the surface surrounding the point, utilizing a number of distance measuring elements such as laser range finders to measure the distance with sufficient accuracy to make triangulation possible. These measurements are then used to mathematically calculate the orientation of the measurement apparatus with respect to the targeted point on the surface. Accuracy of the measurement apparatus is dependent on such conditions as flatness of the surface with respect to the distance and width between measurement points, accuracy of the distance measuring elements, movement of the user, and physical design of the system.

Some embodiments allow the measurement apparatus to rapidly repeat measurements to the surface allowing the capture of dynamic orientation information while the apparatus and/or the surface is moving. With the ability to capture dynamic orientation information, some embodiments of the invention would allow the user to move to a predetermined orientation with respect to the point on the surface by pointing the device to the desired location on the surface while simultaneously receiving directional information from the output device. Various embodiments have the capability to perform simple operations like determining perpendicularity to the surface, while others are more complex and provide additional metrics such as angle of incidence of a vector from the measurement device to the point on the surface, nearest distance to a plane made by the surface, and three dimensional coordinate system representations of the orientation of the apparatus with respect to the surface.

Some embodiments of the apparatus allow it to be used remotely, to be used by humans, robots, and/or machines, to be contained in a hand held device or to be separated into pieces for more complex applications. Some embodiments are designed to store data and/or convey orientation information to the user in a variety of formats and styles, and to be used with additional components that improve accuracy and add additional orientation metrics to extend the orientation capabilities of the apparatus itself.

Some embodiments also include a memory storage device which make it possible for the user to capture orientation data at one location using a point on the flat surface, move to a secondary location and capture orientation data at the new location using the same point on the surface, thereby being able to calculate a distance between the two locations. Additionally, other embodiments might from one out of plane orientation capture the orientation of a floor, a wall, and then track an object with a flat surface travelling through the area. With the ability to store these locations in the measurement apparatus memory, the scene can later be recreated either within the measurement apparatuses processor, and/or sent out via the interface to a computational system outside of the measurement apparatus for processing. With the capability to store orientations and time stamps, embodiments of the measurement apparatus can use the tracking data to determine change in location with respect to the time stamp thereby estimating velocities and accelerations of moving objects.

### BRIEF DESCRIPTION OF THE SEVERAL VIEWS OF THE DRAWINGS

For a fuller understanding of the nature and advantages of the present concepts, reference is made to the following detailed description of preferred and alternate embodiments, in which:

FIG. 1 illustrates an embodiment of the invention shown as a schematic;

FIG. 2 illustrates an embodiment of the measurement apparatus designed to operate in two dimensions and provide simple directions to the user to achieve a perpendicular state to the surface;

FIG. 3 illustrates the same embodiment of the measurement apparatus as depicted in FIG. 2, with the addition of feedback from the measurement apparatus to advise the user that the desired perpendicular state has been reached;

FIG. 4 illustrates the same embodiment of the measurement apparatus as depicted in FIG. 2, with additional information to aid in describing the mathematical process in the detailed description;

FIG. 5 illustrates a similar embodiment of the measurement apparatus as depicted in FIG. 2, with the exception that the output device displays a measurement in degrees that requires additional mathematics to determine an angle;

FIG. 6 illustrates an embodiment of the measurement apparatus designed to work in two dimensions with an adjustable distance measurement element and transducer;

FIG. 7 illustrates the same embodiment of the measurement apparatus as depicted in FIG. 6, except shown with the device and the distance measurement element moved to a different orientation;

FIG. 8 illustrates an embodiment of the measurement apparatus designed to operate in three dimensions;

FIG. 9 illustrates the same embodiment of the measurement apparatus as depicted in FIG. 8 from a top down view, with the display showing what information is obtainable from this distance measurement orientation;

FIG. 10 illustrates the same embodiment of the measurement apparatus as depicted in FIG. 8 from a side view, with the display showing what information is obtainable from this distance measurement orientation;

FIG. 11 illustrates points made on a flat surface by the various distance measuring elements, and is used to illustrate a complication that occurs when utilizing the two dimensional formulas used in two dimensional embodiments of the measurement apparatus in a three dimensional environment;

FIG. 12 illustrates a reference frame that is used in the details section to describe a constraint placed on the user of the measurement apparatus;

FIG. 13 illustrates an embodiment of the measurement apparatus used in three dimensions, and is referred to in the details section when describing the mathematics used to calculate orientation in a Cartesian reference frame;

FIG. 14 illustrates the same embodiment as in FIG. 13, and is used as a continuation of FIG. 13 in describing the mathematics to calculate orientation;

FIG. 15 illustrates the same embodiment as in FIG. 13, and is used as a continuation of FIG. 14 in describing the mathematics to calculate orientation;

FIG. 16 illustrates an embodiment of the measurement apparatus designed to operate in three dimensions with one primary distance measurement beam, and four ancillary distance measurement beams, in which all distance measurement beams are contacting the surface;

FIG. 17 illustrates the same embodiment of the measurement apparatus as depicted in FIG. 16, however two of the distance measuring beams no longer strike the surface.

FIG. 18 is used to illustrate two embodiments of the measurement apparatus in the details section which involves the user of the measurement apparatus changing position;

FIG. 19 illustrates an embodiment of the measurement apparatus with a bubble level to improve accuracy and a protractor device with attached laser line tool to extend orientation measurement capabilities;

FIG. 20 illustrates an embodiment of the measurement apparatus used in an industrial setting where the components of the apparatus are separately located, connecting circuits are wireless, external output signals are being sent to automatically correct a cart that is off course, and a mobile communication device that is being used both as an output device and as an interface that allows the user to immediately stop the cart if desired;

FIG. 21 illustrates an embodiment of the measurement apparatus used for two dimensional orientation to a circular surface with the device shown in a non-perpendicular orientation to the surface;

FIG. 22 illustrates the same embodiment as in FIG. 21, except with the device in a perpendicular angle to the surface;

FIG. 23 illustrates an embodiment of the measurement apparatus used for two dimensional orientation to a curved surface, with the device showing a coordinate system representation;

FIG. 24 illustrates a potential use of the measurement apparatus in which the measurement apparatus is pointed at one spot on a wall, and the user is signaled to swing a board left to reach a perpendicular state to the wall;

FIG. 25 illustrates a potential use of the measurement apparatus in which the measurement apparatus is used to move a desk along a wall, wherein the measurement apparatus is not pointed at any particular spot;

FIG. 26 illustrates a potential use of the measurement apparatus in which the measurement apparatus is attached to a fork lift type vehicle which desires to pick up a 55 gallon drum, but must approach the drum in line with its center;

FIG. 27 illustrates an embodiment of the measurement apparatus in which a user captures the orientation of a wall, and then from the same location tracks a vehicle through the area thereby later being able to recreate the scene to include movement and speed of the vehicle.

### DETAILED DESCRIPTION OF THE INVENTION

The above described invention allows a user to obtain orientation information with respect to a point on a flat or curved surface in a manner which is simple and yet accurate enough for many day to day applications. The user of this measurement apparatus obtains this orientation information by pointing the measurement apparatus, and/or its distance measuring component, at a point on a flat or curved surface, and upon the measurement apparatus obtaining distance measurements and calculating orientation data, the user will be provided orientation information in many possible forms through an output device.

The measurement apparatus operates on the presumption that the surface surrounding the point of interest is relatively constant in flatness, and/or for curved surfaces, that the surface is either convex or concave in two dimensions and that the convex or concave curvature can be roughly approximated with a polynomial of the second degree which equates to a parabolic and or circular shape. Additionally, the surface surrounding the point of interest must extend far enough from the point so that distance measurements to the surface are sufficient in angular separation and distance so as to make triangulation from the surface to the measurement apparatus feasible. Factors such as accuracy and orientation of the distance measuring elements, flatness of the surface and/or consistency of the curve will all play a role in determining the accuracy of the resulting orientation data.

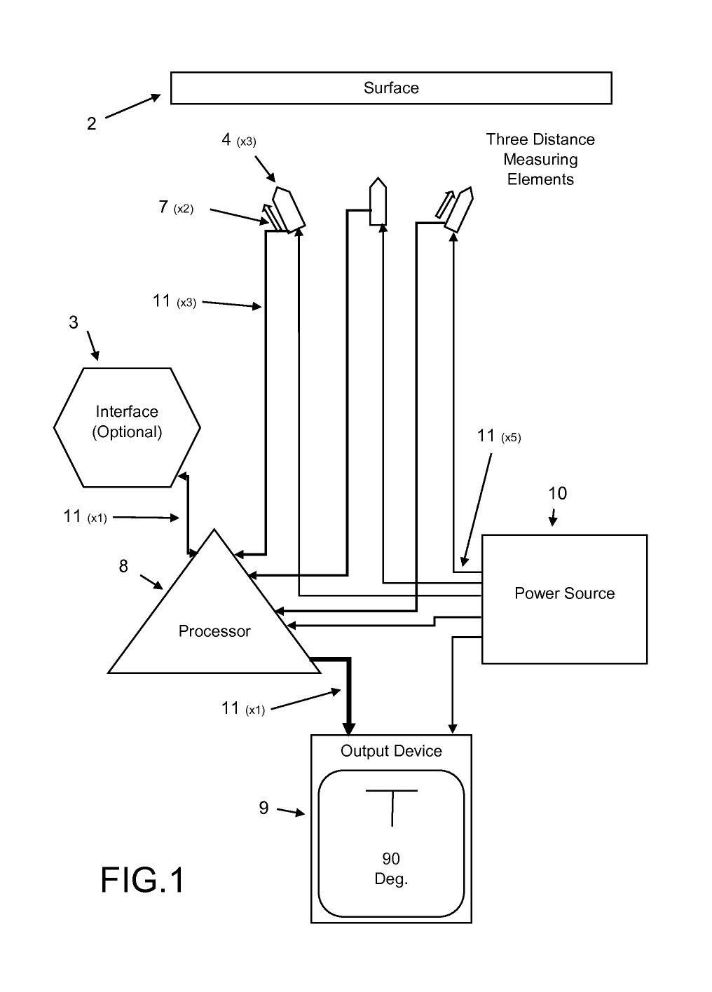

Provided that the surface is suitable for obtaining the measurements, a basic embodiment of the invention operates as follows. FIG. 1 illustrates a simplified schematic view of an embodiment the measurement apparatus. Three distance measuring elements (4) are shown, and all three appear to lie in a plane while pointing toward different areas on the surface (2). The distance measuring elements contain distance measuring circuitry (not shown) that are capable of measuring the distance from the distance measuring element to the surface. Although different types of distance measuring elements exist that may be suitable for this application such as sonar, the embodiments shown in this application generally depict a coherent light source such as that used by a laser range finder. Utilizing laser range finders would be preferred for most applications as the measurements can be obtained quickly, tend to possess the level of accuracy needed for this application, and often operate in the visible light spectrum which allows human users of the measurement apparatus to see where the measurement apparatus is pointing and where the various distance measurements are being taken.

The three distance measuring elements (4) depicted in FIG. 1 are arranged so as obtaining a set of distance measurements is possible. Obtaining a set of distance measurements in this application refers to obtaining at least two distance measurements to at least two different locations on the surface (2), without necessitating external movement of said measurement apparatus or any of its comprised parts. The ability to obtain distance measurements without externally moving the measurement apparatus or any of its parts is what gives the measurement apparatus a ‘point and shoot’ feel quality when used.

In regard to obtaining the set of distance measurements, the individual distance measuring elements do not necessarily need to take all of their distance measurements at the same time to form a set of distance measurement, but designing the measurement apparatus to do so decreases the likelihood of introducing error by inadvertently moving the measurement apparatus while in the middle of obtaining a single set of measurements. If the measurement apparatus obtains its set of distance measurements at or near the same time, then the measurement apparatus can be placed into motion while obtaining repeated sets of distance measurements. This allows the user to track a point on a moving surface, and/or move while pointing the measurement apparatus at a given point on a surface thereby creating tracking data. In this manner as described later, some embodiments can provide directions to a user to instruct that user to a predetermined orientation.

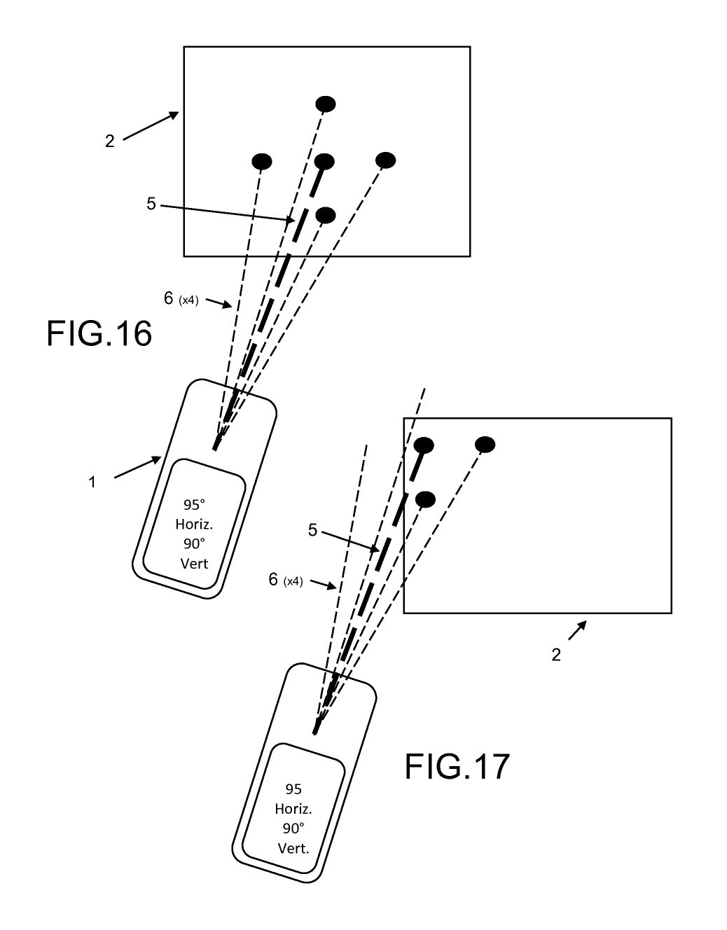

To obtain two dimensional orientation information, an embodiment of the measurement apparatus would need to point to at least two different locations on the surface, with at least two distance measuring elements casting distance measurement beams that are contained in the same plan. To obtain three dimensional orientation information, an embodiment of the measurement apparatus would need to point to at least three different locations on the surface, with the distance measurement beams being non-linearly dependent with respect to each other, meaning that two of the distance measuring element distance measurement beams could be contained in one plane as described for the two dimensional version, however the third could cross the plane but not be contained within the plane. Additional distance measuring elements may be added to either of these devices to improve accuracy (by allowing multiple measurements to be averaged), and/or to improve usability (an embodiment of the measurement apparatus described later in FIG. 16 and FIG. 17 describes such a usability situation).

The distance measuring elements (4) in FIG. 1 all appear to lie in the same plane, which would indicate this measurement apparatus would be used to obtain two dimensional orientation information, and that although three distance measuring elements are present, this embodiment of the measurement apparatus could still function in a similar manner with only two distance measuring elements.

The distance measuring elements, as will be discussed later in this section, need to have an orientation with respect to the out of plane orientation that is being reported by the measurement apparatus that is known. Aspects of this orientation information is required knowledge since the mathematics to determine distance via triangulation and/or distance comparison take into account the orientation of the distance measuring elements. In an embodiment of a measurement apparatus in which the distance measuring elements are fixed into a specific orientation, the physical orientation of these distance measuring elements is already known from the inventions design. In other embodiments of the invention, the distance measuring elements may be moved to different orientations, and in these cases, one or more transducers would be utilized to capture the change in distance measuring element orientation, and would send this orientation information encapsulated into a signal to the component responsible for mathematical calculations.

In regard to orientation, the distance measuring elements may be arranged in numerous different orientations with respect to one another, however certain orientations simplify the mathematics and/or have an inherent advantage in their layout to the user. For instance, one preferred embodiment is to have a primary distance measuring element pointing out the physical portion of the measurement apparatus that is pointed at the surface toward the point on the surface, while having one or more ancillary distance measuring elements pointed toward other locations on the surface. This arrangement is preferable in that if the distance measuring element is utilizing a coherent light source, then the user can observe were the device is pointed. As will be discussed later, another preferable arrangement in some of the three dimensional orientation embodiments of the measurement apparatus, is to have an ancillary distance measuring element pointing either directly above or below the primary distance measuring element while using visible laser type distance measuring elements, since this arrangement is useful for a human user to hold the measurement apparatus in an upright position, by confirming that the primary and ancillary measurement beams are vertical with respect to one another.

So far, the distance measuring elements discussed have involved independent distance measuring elements to measure the distinct locations on the surface, however it should be noted that laser scanning elements have been manufactured, as well as elements that can alter the direction of their sensing device, and nothing precludes the use of such devices. However for clarity of understanding pertaining to distance measuring element orientation, all figures in this application show independent distance measuring elements.

As shown in FIG. 1, distance measurements made by the distance measuring elements (4) are relayed to a processor (8) which is the component of the measurement apparatus that uses any combination of these distance measurements, knowledge of the distance measuring elements orientation, information from any transducers (7) present, and or any other available data provided either internally and or externally to mathematically and programmatically calculate a measurement result. The measurement result is dependent on the particular embodiment of the invention. For example, in some embodiments, the final output that the user receives may be a numerical result, but the result might also be a direction in which to turn. In this case, the measurement result may be a representation of an indication that the user needs to turn to the right in order for the front to be perpendicular to the surface. The processor might therefore calculate the current rotational angle from the surface, compare this result against a known value, such as 90 degrees which is arbitrarily chosen in this application to mean perpendicularity, and then present an option. For example, if the calculated result is larger than 90 degrees, the user would be instructed through the output to turn one direction. If the calculated result is smaller, the user would be instructed to turn the other direction. And if the result was within some tolerance specified by the embodiment, then the user might be alerted that he or she is perpendicular to the surface. The measurement result encapsulated in the output signal would therefore be some representation of turning left, turning right, or a ‘success’ notation. The measurement result may however take on other forms that will later be processed into an output that may include a graphical display with images, numbers, and possibly even bilingual text. Other forms of measurement result may include incremental, conditional, and or logically framed results. Once the measurement result is developed by the processor, it is then encapsulated into an output signal that is used to relay the measurement result to the output device. Common output signals might include analog and/or digital representations of the measurement result.

As depicted in FIG. 1, the output signal generated by the processor is then routed to an output device (9). As described in the processor section, the output device might assume different forms depending on embodiment. For instance, the output device might consist of two lights, one that tells the user to turn left, one to turn right, and both lights illuminate to advise the user that a successful condition has been met. In other embodiments, the output device might be a graphical display that shows images of the orientation of the point on the surface, the surface, and the location of the measurement apparatus along with numerical data to describe angles and distances. The possibility exists that the output device uses additional output from other sources in conjunction with the measurement apparatus' output, such as overlaying graphical orientation data on a digital picture that was taken by a digital camera accessory attached to the measurement apparatus in order to show perspective. The output device may also be designed with a small motor that vibrates when a specific condition is met so that the user does not need to watch the display. Other embodiments may provide a voice narrator that narrates directions to reach a desired orientation. Other embodiments may have the output signal routed to another device, wherein perhaps the output signal is used to control a motorized device on which the measurement apparatus is mounted. Much as with the measurement result, the output device has a wide variety of potential manifestations based on the variety of formats in which output can be provided. Additional output formats might include tactile responses, visible displays, auditory display, mechanical device response, electronic response, and/or any other method of communication understood by a user.

As depicted in FIG. 1, power required for the measurement apparatus or any of its components is supplied by a power source (10). The power source can take any form to include power storage, such as a battery, constant power source, such as electricity from an outlet, and/or utilizing a power generation method, such as a solar array. Any combination of these forms of power sources to power the measurement apparatus in whole or in part would be appropriate provided enough power can be supplied to operate the measurement apparatus.

The various components of the measurement apparatus as described above send signals back and forth, and this is accomplished through a single or plurality of connecting circuits (11). The connecting circuits relay the distance measurement signals from the distance measuring elements to the processor, the transducer orientation measurements to the processor, the output signal from the processor to the output device, the power from the power source to the various components requiring power, and the various other connections to and from the measurement apparatus and/or any of its accessories.

Finally the measurement apparatus contains one or more supports (not shown), wherein the support consists of any number and/or combination of supports comprising cases, devices, fasteners, and/or any other components that can be used to support and/or orient the above described components.

An interface (3) is not a required component of the measurement apparatus, however most embodiments would typically have some type of interface even if it was switch to power the measurement apparatus on or off. The interface is the device that provides a means for the user and other external entities and/or systems to communicate back and forth with the measurement apparatus, its components, and/or any accessories. The interface could be as simple as a switch, or might include a keypad and graphical display to provide the user with menus and other displays to show the status of the system, its inputs, and/or its outputs. The interface is what allows communication between the measurement apparatus and its user and/or other external entities and/or systems. In some embodiments, the interface may provide the means that the user utilizes to enter data pertaining to desired location to be directed to. The interface might also be used in the embodiment described earlier wherein a digital picture is taken by an accessory device. In this case, the interface might communicate with the camera through electronic signals to signal the camera to take the picture in concert with the distance measurements being taken. The camera might then relay the digital picture information back to the interface so that the picture information could be utilized in the output. Other uses of the interface might include entering additional input parameters to the mathematical calculations, entering offsets to the desired orientation, measurement unit choices, reference frame choices, distance measurement beam orientation and control choices, brightness of distance measurement beam and/or display options, and choosing different measurement set collection methods such as: single set, repeating set, and/or initiating a set based on an internal and or external signal.

Various embodiments of the measurement apparatus might also include control circuitry and devices that provide a means for the measurement apparatus to control its own state and/or its own components. For instance, the measurement apparatus may have an automatic power on/off feature which turns the measurement apparatus on when it is moved, or powers it off when it hasn't been moved for a predetermined length of time. The measurement apparatus might also have a feature that automatically changes the orientation of the distance measurement element when a given element detects a sudden change in distance which might indicate the distance measurement element is no longer pointed at the surface. Instead of altering the orientation, an embodiment might note the sudden change and turn off that particular distance measuring element leaving the measurement apparatus to rely on distance measurements made by other redundant distance measuring elements.

Some embodiments of the measurement apparatus may utilize connecting circuits that include components necessary to send signals utilizing wireless, cellular, and or other cordless technologies. This might be required when the user is in a location that is away from the measurement apparatus, or possibly in environments that are too dangerous for the user to enter.

Some embodiments of the measurement apparatus may realize a significant portion of their components utilizing computer related hardware and/or software. For instance, many mobile phones contain the display, interface, processor, power source, and connecting circuits necessary to realize the majority of the measurement apparatus' components. Therefore an embodiment of the measurement apparatus may take this into consideration, and with the addition of software and a small structure that contains the distance measuring elements and distance measuring circuits with a connection to plug into a port on a mobile phone, a measurement apparatus might be realized.

Other embodiments of the measurement apparatus may be wholly contained in a small case with a grip suitable for the human hand. This arrangement might be suitable for use at a construction site or as a tool to be used in the home.

Additionally, some embodiments may include a support that permanently houses additional accessory devices, and or fasteners to temporarily fasten accessories to the measurement apparatus. These accessories might include devices such as the camera discussed earlier, and/or other accessories that improve accuracy and/or extend the capabilities of the measurement apparatus beyond what it can do by itself. For example, to improve accuracy, the measurement apparatus may have attached to it sighting systems, gyroscopes, weighted grips to promote certain orientations, automatic tracking devices, leveling devices, inclinometers, plumb bobs, support devices, and/or additional range finders. Additionally, accessories may provide a means for the measurement apparatus to extend its capabilities beyond itself. For instance, laser line tools have been manufactured that create a line on the ground. Such an accessory device attached to the measurement apparatus might show a user where a 45 degree angled line would lie from an orientation that is perpendicular to a point on the surface. Other accessories that may extend the capabilities of the measurement apparatus might include laser light sources, protractors, straightedges, compasses, tape measures, and other angle finding devices.

Some embodiment might include a memory storage device that stores information comprising any combination of distance measurements, measurement results, inputs, outputs, time, and or state of the system. Used in conjunction with the processor and the output display, this provides a means for the user to measure out of plane distances. This can be accomplished by utilizing the measurement apparatus to capture orientation information at one location, and then moving to a secondary location while pointing the measurement apparatus at the same point on the surface as used when obtaining the initial orientation, a distance between the two locations can be computed utilizing trigonometry and/or mathematical distance formulas. Other uses for the stored data might be to calculate tracking history of a moving object and/or to provide a means for the user to store several orientation locations without having to stop and write down a description of each orientation. With the addition of storing time stamps of orientation data, the processor can determine velocities and accelerations based on the change in position of a moving surface divided by the time difference between orientations. Change in velocities over change in time would then provide acceleration data.

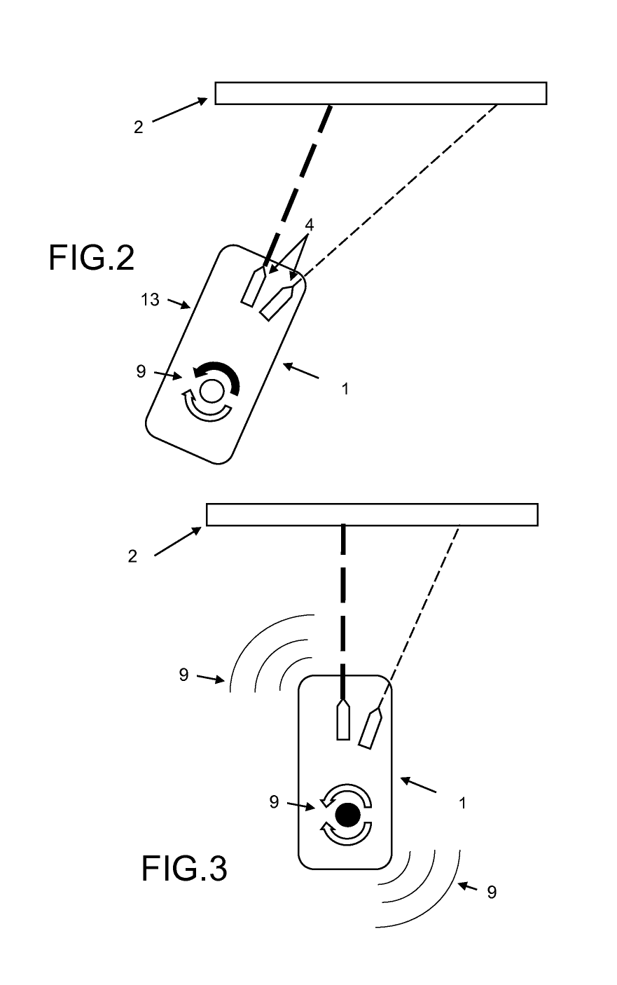

FIG. 2 illustrates an embodiment of the invention in which a small handheld measurement apparatus (1) is used to determine perpendicularity to a flat surface (2). In this embodiment, two distance measuring elements (4) are used to measure two points on a surface. This would represent an example of a two dimensional measurement apparatus, with distance measuring beams that are non-symmetrical about a vector from the measurement apparatus to the point on the surface. FIG. 2 shows the measurement apparatus (1) in a non-perpendicular orientation with respect to the surface (2). The measurement apparatus (1) has apparently collected a set of distance measurements, has calculated a measurement result, and has sent a signal to the output device (9) that the user needs to rotate left to reach a perpendicular state, and the output device (9) displays this with an indication to rotate left. FIG. 3 illustrates the same measurement apparatus (1), however the orientation of the device has been changed to a perpendicular orientation. The output device (9) is signaling that the desired perpendicular state has been reached by illuminating a dot in the middle of the output display (9), and by vibrating which is represented in FIG. 3 by the curved lines on opposite corners of the measurement apparatus (1).

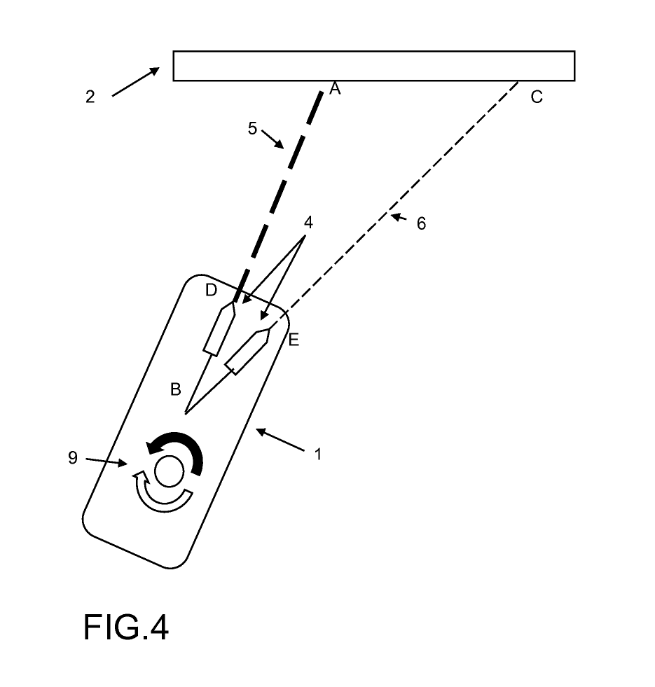

FIG. 4 illustrates the same measurement apparatus (1) as depicted in FIG. 2 and FIG. 3, however letters have been added to facilitate describing the mathematical process that might be used by the processor to calculate the measurement result. The primary measurement beam (5) strikes the surface (2) at point A. The ancillary measurement beam (6) strikes the surface at point C. The actual out of plane orientation that is being determined is located at point B, which lies at the point where the imaginary extension of the distance measurement beams (5 & 6) to the location at which the two distance measurement beams would cross. D represents the tip of the primary distance measuring element (4) from which the distance measuring circuit calculates the distance to A. E represents this same location with respect to the ancillary distance measurement beam obtaining the distance to C. Since knowledge of the physical orientation of the distance measuring elements (4), including angle and distances, is required per the stated claims of this invention, the distance BD (notation for the distance between B and D) and distance BE is either known by measurement and/or by calculation using the equations describing right angle trigonometry (if any angle in the triangle BDE (a triangle made by the points B, D, and E) is 90 degrees, the triangle is referred to as a right triangle), and/or the Law of Cosines (if not a right triangle). Further information pertaining to the Law of Cosines and/or equations relating to right angle trigonometry can be found in most college level trigonometry textbooks. Since the distance BD is known and/or can be calculated, and since the distance DA is obtained via the primary distance measuring element, the distance BA is known by addition of the two distance values. The same is known of B, E, and C, therefore the distance BC is also known. Additionally, the angle ABC (an angle at B made by a vector from B to A and another vector from B to C wherein the notation always places the common point of the vectors in the middle of the three letter angle designation), is also known by measurement and/or by calculation using the Law of Cosines and/or right angle trigonometry. Therefore based on the orientation of the distance measuring elements, and the distance to the flat surface at two points, and utilizing the assumption that the surface (2) is flat and therefore the line from A to C is straight, perpendicularity to the surface can be determined by utilizing the equations of right angle trigonometry. An equation that could be used for this situation under the assumption that the desired angle to be 90 degrees to indicate perpendicularity to the surface is angle DAC:

$$COS ( angle , ABC ) = \frac{distance AB}{distance BC}$$

This equation will not in itself tell a user which direction to rotate, however it will tell a user that when the value on the left equals the value on the right, that perpendicularity has been achieved. To determine the direction to rotate, one could examine the ratio on the right side of the equation and compare it to the value on the left. If the value on the right side of the equation is smaller than the value on the left side of the equation, this would indicate that either the numerator is too small and or the denominator is too large. This would happen to be the case if the measurement apparatus was oriented as shown in FIG. 4. One can see that to be perpendicular that either the distance AD would need to be increased, and/or the distance BC would need to be decreased, which can be accomplished easiest if the user rotates counterclockwise or to the left. Therefore the processor could use this process of calculation and comparison to determine perpendicularity and/or direction to reach perpendicularity to the surface, and send a signal to the output device (9) that depicts to the user what needs to be done.

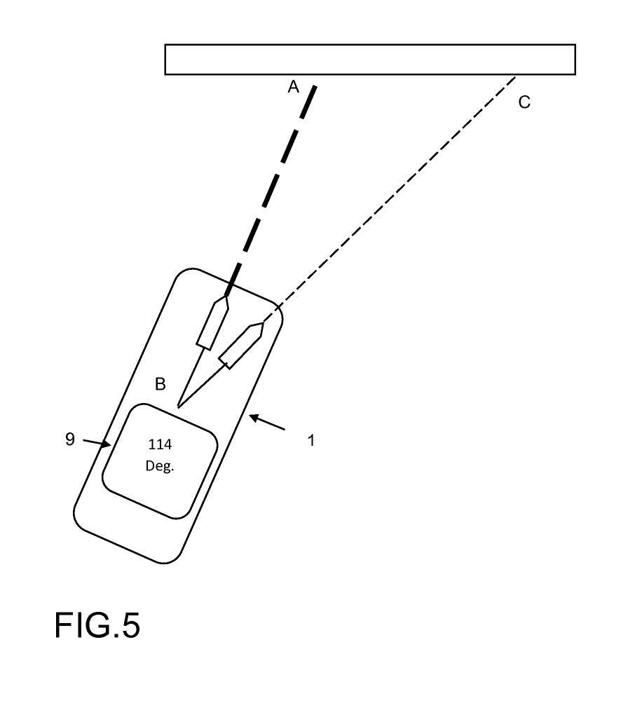

FIG. 5 shows a similar embodiment of the measurement apparatus (1) that was described in FIG. 4, however the output device (9) in this case appears to be a digital display that shows an actual angle in degrees. This embodiment would require a processor capable of more complex calculations. The same basic method to identify distance AB and BC would be utilized as in what was described for FIG. 4, so only points A, B, and C will be discussed. For this situation, the Law of Cosines can be utilized to obtain orientation information. The output device (9) displays the angle BAC. If the output device displays 90 degrees, then the user knows that a perpendicular state has been reached. The first step in the process would be to determine the distance AC. The Law of Cosines used in a form to solve for this value would be:

$$distance A C = \sqrt{\begin{matrix}{( distance AB )}^{2} + {( distance BC )}^{2} - 2 * \\ ( distance AB ) * ( distance A C ) * cos ( angle ABC )\end{matrix}}$$

The Law of Sines (which can also be found in most college level trigonometry text books) can then be used to solve for angle BAC as follows:

$$angle BAC = arcsin ( distance BC * \frac{sin ( angle ABC )}{distance A C} )$$

The processor now has the value of the angle which can be sent as a measurement result to the output device (9) and displayed to the user.

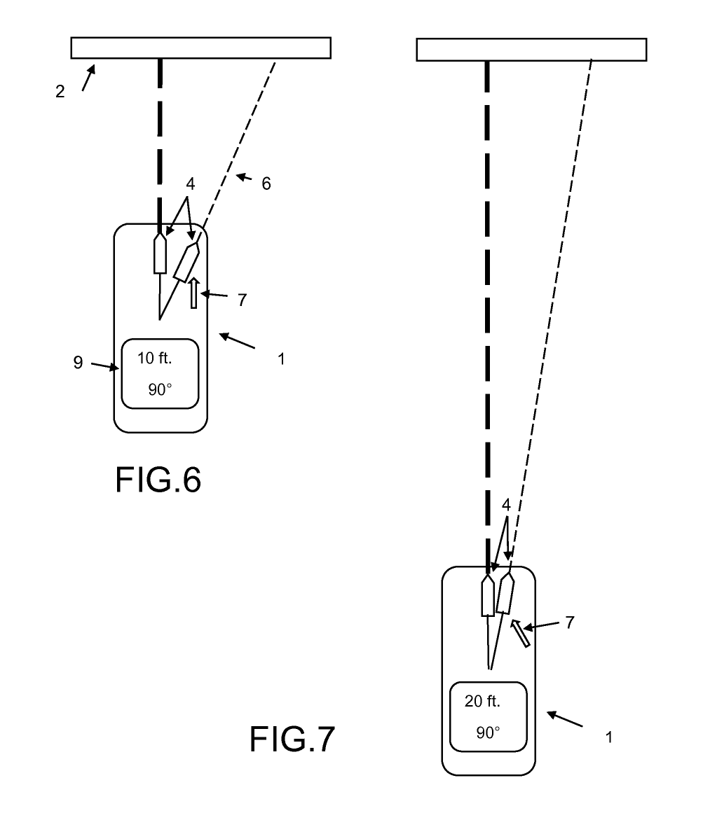

FIG. 6 illustrates an embodiment of the measurement apparatus (1) that is similar to that shown in FIG. 5, however the measurement output device (9) displays a distance to the surface, and additionally the measurement apparatus (1) is equipped with a transducer (7) which indicates that the ancillary distance measuring element (4) in this embodiment can move. In the situation illustrated in FIG. 6, the flat surface (2) is small, but appears to be sufficient in size for distance measurements when the measurement apparatus (1) is 10 feet from the surface (2). However, if the measurement apparatus (1) was moved back to 20 feet, the ancillary distance measurement beam (6) would likely miss the flat surface (2) thus making the measurement apparatus (1) unusable at that distance. Therefore, this embodiment of the measurement apparatus (1) provides for the possibility of changing the angle between distance measuring elements (4). As the user moves the measurement apparatus (1) back to 20 feet as illustrated in FIG. 7, the angle between the distance measuring elements (4) is decreased via external movement of the measurement element by the user and/or by an added control device that moves the distance measuring element (4). As the distance measuring element (4) moves, the transducer (7) reports the new angle between the measurement elements (4) to the processor, which now can utilize the same equations used to describe the apparatus in FIG. 5 to calculate the measurement result.

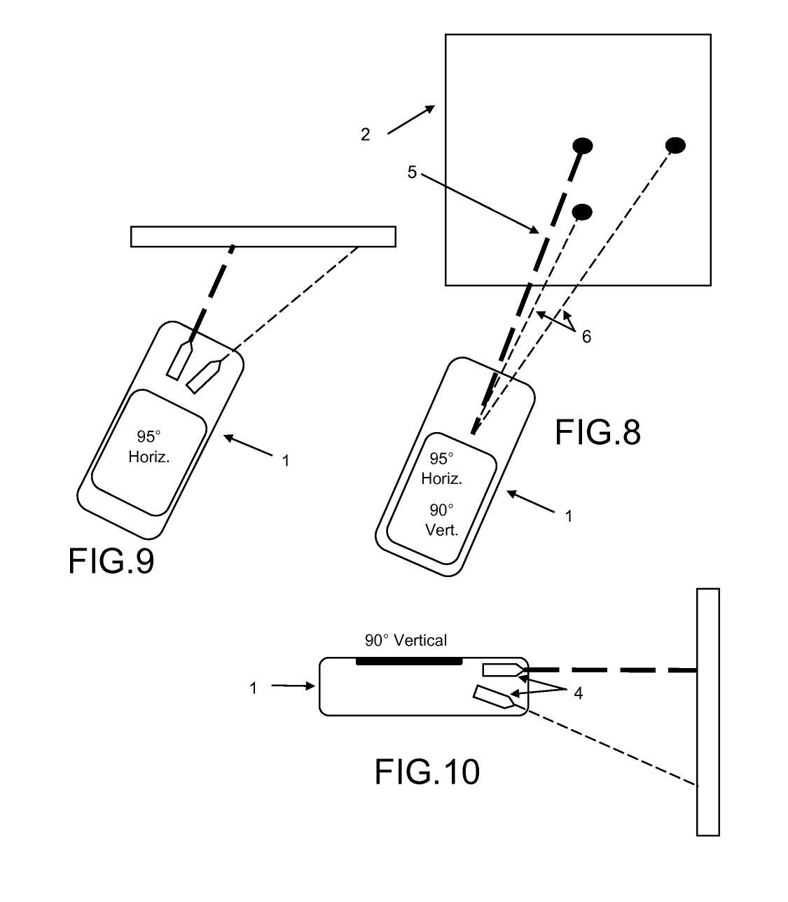

FIG. 8 illustrates an embodiment of the measurement apparatus (1) utilized for three dimensional orientation information. The device is shown with three distance measuring elements (not shown) casting three distance measuring beams (5 & 6), a primary distance measurement beam (5) from the front of the measurement apparatus to the surface (2), an ancillary distance measurement beam (6) pointed to a location to the right of the primary distance measurement beam (6), and a third ancillary distance measurement beam (6) pointed to a location below the primary distance measurement beam (5). FIG. 9 illustrates the same measuring apparatus (1) from the top view, wherein the third distance measuring element is not visible since it is directly below the primary distance measuring element (4). FIG. 10 illustrates the same measuring apparatus (1) from the side view, wherein the second distance measuring element is not visible due to being in line with the primary distance measuring element (4). Although the top view and side view appear as if the measurement apparatus (1) could utilize the same equations as presented in the illustration of FIG. 5, this assumption would only be correct if the user was perpendicular to the surface and either moved the device straight up and down, or only left and right.

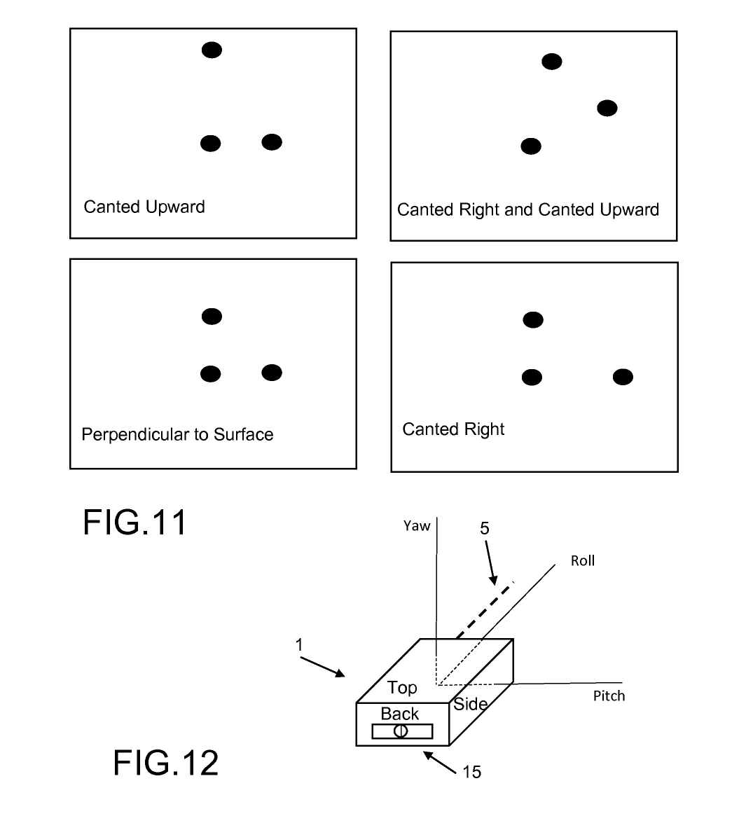

FIG. 11 illustrates the reason that additional mathematics is required when determining orientation in three dimensions. FIG. 11 illustrates points on a flat surface at which the distance measuring elements of an unseen measurement apparatus is pointed. The bottom left frame of FIG. 11 illustrates these points if the measurement apparatus were perpendicular to the surface. The upper left frame of FIG. 11 illustrates the points if the measurement apparatus were canted upward. One can see that the top point has stretched upward. The bottom right frame of FIG. 11 illustrates the points if the measurement apparatus were rotated right. One can see here that the right point has stretched further right. The upper right frame of FIG. 11 illustrates the points if the measurement apparatus were rotated right and canted upward. From this last image it can be seen that the points become distorted, and no longer do they line up in an up and down or side to side fashion. This unequal stretching phenomenon is why the previous equations no longer work in other than specific orientations. They would calculate an orientation, but the values would align to a distorted orientation, and no longer a purely horizontal and vertical orientation.

One solution to this issue is for users to use the measurement apparatus within certain constraints. To simplify explanation of the constraint, FIG. 12 illustrates a measurement apparatus (1) in a three dimensional view. An axis has been placed at the center of the measurement apparatus, and in this orientation, the measurement apparatus' distance measuring elements (not shown) would be casting a primary measurement beam (5) out the front of the measurement apparatus, which is the side opposite the back. Borrowing terminology used by most pilots when describing an airplane in flight, the same terminology will be used to describe the orientation of the measurement apparatus (1). Changing the yaw of the measurement apparatus (1), would be rotating the device about the axis labelled yaw. Changing the pitch of the measurement apparatus (1) would be rotating the device about the axis labelled pitch, and changing the roll of the measurement apparatus (1) would be to rotate the measurement apparatus (1) about the axis labelled roll.

The proposed solution to counteract this stretching phenomenon is for the user to avoid rolling the device. To facilitate this, a bubble level could be placed horizontally on the back of the device for those situations in which a user is likely to use the embodiment of the measurement apparatus in an area with upright walls such as in a house. Humans tend to maintain this orientation naturally when looking through binoculars and/or when holding devices that have pistol style grips.

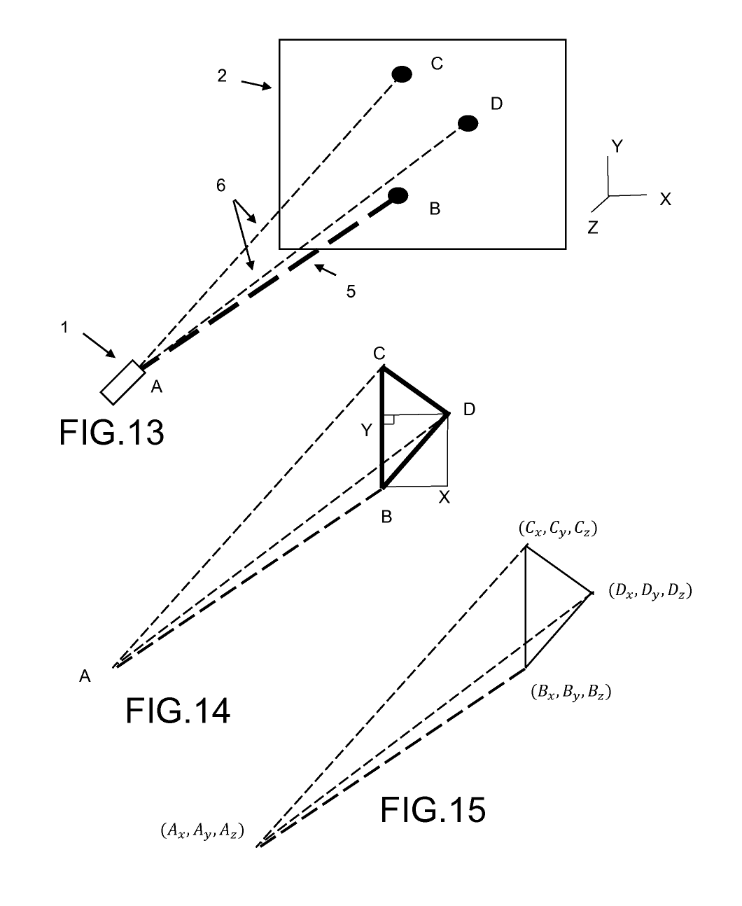

Additional confirmation of this orientation can be made if the embodiment of the measurement apparatus contains distance measuring elements utilizing coherent light beams that can be seen reflecting on the flat surface. FIG. 13 illustrates such an example. In this embodiment, the primary distance element is casting a primary distance measurement beam (5) out of the front of the measurement apparatus toward the point of interest marked B. The ancillary distance measurement beam AC (6) is tilted up from the primary distance measurement beam AB (5). The ancillary distance measurement beam AD (6) is tilted to the right of AB. The measurement apparatus (1) depicted has been pointed up and to right on that flat surface as described earlier in the upper right frame of FIG. 11, however the user has not rolled the measurement apparatus (1), and therefore the two vertically oriented beams are still vertical. By maintaining the constraint of not rolling the device, confirmed by either the use of the bubble level and or visual confirmation that the two points are still vertical, the user has now created a reference frame that is consistent as the measurement apparatus (1) is pointed to different locations on the flat surface (2), and/or if the user chooses to move to a different location.

To calculate three dimensional orientation with respect to the point on the flat surface, one potential method is to change the reference frame into a Cartesian based coordinate frame. The following description can be conceptualized while examining FIG. 13. To define this reference frame, the following assumption will be made. The X axis and Y axis are perpendicular and both lie on the flat surface (2). The Z axis is orthogonal to X and Y, and comes out of the flat surface (2) and is used to define the extent away from the flat surface (2) that the out of plane orientation exists. By requiring the user of the measurement apparatus (1) to avoid rolling the measurement apparatus (1), the user has now constrained the orientation so that the two vertical points on the surface both lie on the Y axis. To further constrain the coordinate system, the primary measurement beam (5) will be declared to define the point on the XYZ coordinate system (0, 0, 0). Due to the measurement apparatus (1) being pointed up and to the right, the ancillary distance measurement beam (6) that projects to the right of the primary measurement beam (5) is now distorted, and contains some positive X and Y value, however since it lies on the plane, it still has a Z value of zero. The measurement apparatus (1) has an unknown X, Y, and Z value, however implied from the orientation, X and Y would both be negative, and Z would be positive.

To solve for orientation in the three dimensional coordinate frame, FIG. 14 illustrates the same situation represented in FIG. 13, however with lines added to clarify the triangle that is made on the flat surface, and with the removal of the measurement apparatus and surface. Due to the requirement that orientation information regarding the distance measuring elements orientation with respect to each other is known (as discussed earlier), and utilizing mathematical processes already described, the following is known about the diagram illustrated in FIG. 14: The distances AC, AD, and AB are known values, as are the angles CAD, BAC, and DAB (as shown earlier when describing FIG. 4). Additionally, using the Law of Cosines (as was done in describing FIG. 5), the distances CD, DB, and BC can also be determined. Since B has been declared to lie at the point (0, 0, 0), we now know the coordinates of point C to be (0,(distance BC),0). Using the Law of Cosines with angles BC, CD, and DB known, the angle CBD can also be determined. Using the equations of right angle triangles, the coordinates of D can be determined as follows:

X_{(coordinate of D)}=length BD*sin(angle CBD)

Y_{(coordinate of D)}=length BD*cos(angle CBD)

With the coordinates of all three points defined, the coordinates of the out of plane orientation can now be determined. One method of accomplishing this is by realizing that three vectors of a pre-specified length (depicted here as distance AC, AD, and AB), wherein each is associated to a different point on a plane (point C, D, and B), and wherein each is linearly independent, and wherein each terminates at the same point in space (point A), and wherein each is further constrained that the measurement apparatus must exist in real space (and not in a mathematically defined imaginary space), that only one solution exists in three dimensional space (since the negative Z solution can be disregarded since we know we are on only one side of the flat surface). The method of determining this is to simultaneously solve three distance equations, knowing that all three share the same point A. To further facilitate understanding, FIG. 15 illustrates the same image portrayed in FIG. 14, however points A, B, C and D have been given coordinates. As discussed earlier, the coordinates of B, C, and D have been fully defined, and therefore the only unknown is the coordinates for A. Each equation is solved using the distance formula, which states that in an orthogonal defined coordinate system, that the distance between two points can be determined by the square root of the sum of the squared differences in each of their X, Y, and Z values. Therefore, the three equations are each a representation of the distance formula from their respective points to the common point A using the distance associated with each point. Solving the following three equations with three unknowns using techniques found in college level calculus and/or linear algebra books will provide the coordinates of A.

distance AC=\sqrt{(Cₓ−Aₓ)²+(C_{y}−A_{y})²+(C_{z}−A_{z})²}

distance AB=\sqrt{(Bₓ−Aₓ)²+(B_{y}−A_{y})²+(B_{z}−A_{z})²}

distance AD=\sqrt{(Dₓ−Aₓ)²+(D_{y}−A_{y})²+(D_{z}−A_{z})²}

With the coordinates (Aₓ, A_{y}, A_{z}) known, the processor can develop a measurement result and the output device can now display a three dimensional coordinate system depicting the orientation of the out of plane location with respect to the out of plane point on the flat surface. Additionally, if the vertical and or horizontal angles of incidence were desired, and/or if any offsets were desired to be calculated, these values could be calculated from the coordinate system using similar methods of mathematics and trigonometry as those that have already been discussed.

FIG. 16 illustrates an embodiment of the measurement apparatus (1) in which 4 ancillary distance measuring elements (6) surround a primary distance measuring element (5). The advantage of such an orientation is that a user can now target virtually any point on the flat surface (2) while still being able to obtain orientation information. For instance, FIG. 17 shows the same embodiment, however the user has moved the primary distance measurement beam (6) to a point near the top left corner of the surface (2). Two of the ancillary distance measurement beams (6) are no longer striking the surface (2), however three dimensional orientation information can still be calculated using the three distance measurement beams (5 & 6) that remain on the surface (2). To avoid erroneous measurement data from the two distance measurement beams (6) that no longer remain on the surface (2), these distance measurements might be disregarded automatically, perhaps based on sudden changes in distance measurements that might occur when the beam departs the surface (2), and or might be turned off manually by the user.

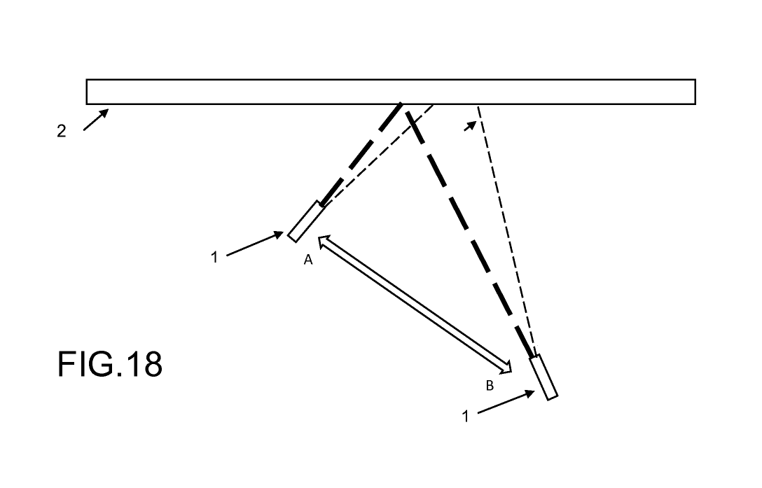

FIG. 18 illustrates a situation in which the measurement apparatus (1) has been pointed at a specific point on the surface, and then has been moved to another location while keeping the measurement apparatus (2) pointed at the same location. This illustration will be used to describe two different embodiments of the invention. In one embodiment, the measurement apparatus (1) is designed to provide instructions to the user to reach a predetermined orientation. The user, currently at point A, points the measurement apparatus (2) at the desired point on the surface (2) after entering the desired location, point B, into the measurement apparatus' interface. The user then continues to point at the same location on the surface (2), as the measurement apparatus' processor continues to receive distance measurement data, calculates orientation, compares orientation to the desired orientation, and sends out an output signal encompassing the desired movement. The output device then reveals to the user the required direction of movement to reach point B. This process is repeated continuously, so that the user can be directed to the desired orientation in the most direct manner. A second embodiment of the measurement apparatus (1) would be used to calculate distances between out of plane orientations. Using a coordinate plane representation as discussed earlier, the user would obtain the coordinates at point A while pointing to a suitable location on the flat surface. The coordinates of point A are stored in the memory device incorporated into the measurement apparatus (1). The user then moves to point B, and again captures the coordinates while pointing at the same location on the surface (2) as used earlier. The measurement apparatus then uses the earlier described distance formula to calculate the distance between point A and point B.

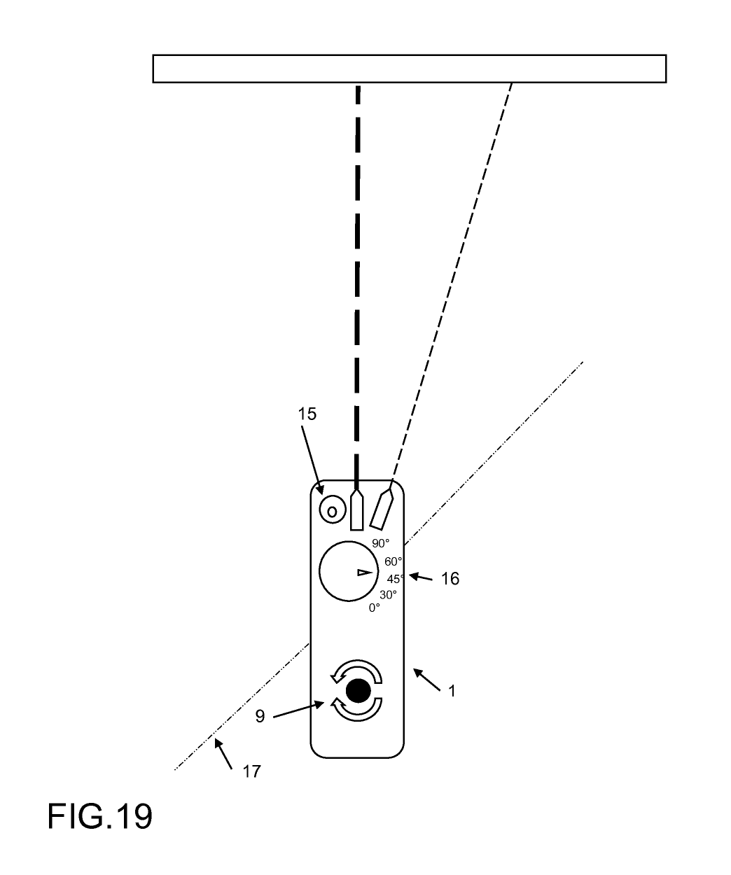

FIG. 19 illustrates an embodiment of the invention in which additional accessories are attached. The measurement apparatus (1) contains an output display (9) that determines perpendicularity. A bubble level (15) is attached to the measurement apparatus (1) so that the user can confirm that the measurement apparatus (1) is being held in a level fashion thus improving accuracy. Also incorporated into the measurement apparatus (1) is a laser line tool designed to draw a line (17) on the ground. The laser line tool is incorporated with a protractor type scale (16) that allows the user to choose an angle for the laser line tool to make. The laser line tool makes a line (17) on the ground at the specified angle, thus providing orientation data that extends beyond what the measurement apparatus (1) can provide on its own.

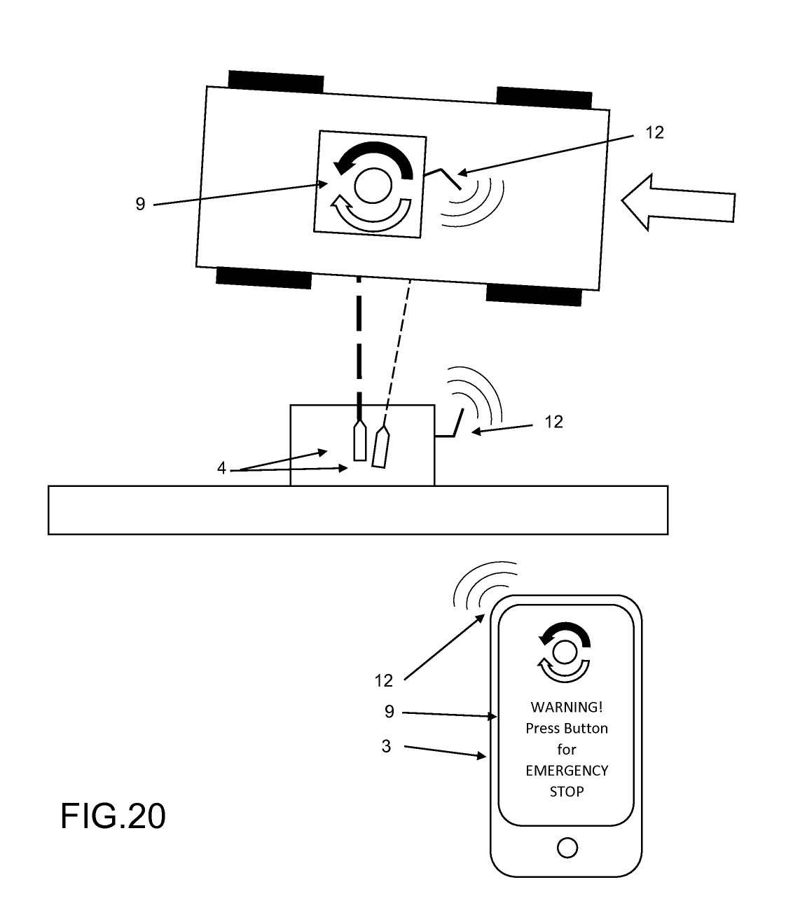

FIG. 20 illustrates an embodiment of the invention with several added features. This embodiment might be utilized in an industrial setting where alignment of some type of cart is required. In this embodiment, the distance measuring element (4) components and possibly the processor are located separately from the output device (9) components. The distance measuring element (4) components and possibly the processor are mounted to a wall in an area in which self-propelled vehicles travel. In the depicted situation, the cart is not in a parallel alignment with the wall, therefore the processor sends a wireless signal (12) to the cart that signals it to rotate counter clockwise. The onboard control mechanisms then initiate a command to the cart to turn. Simultaneously, the wireless message (12) that is sent to the cart is also sent to a user's cell phone shown below. The user receives an output signal on their cell phone (also known as their output device) (9) that displays the warning regarding the cart that is out of alignment. The cell phone also acts as an interface (3) that provides a means for the user to send a command for the vehicle to stop.

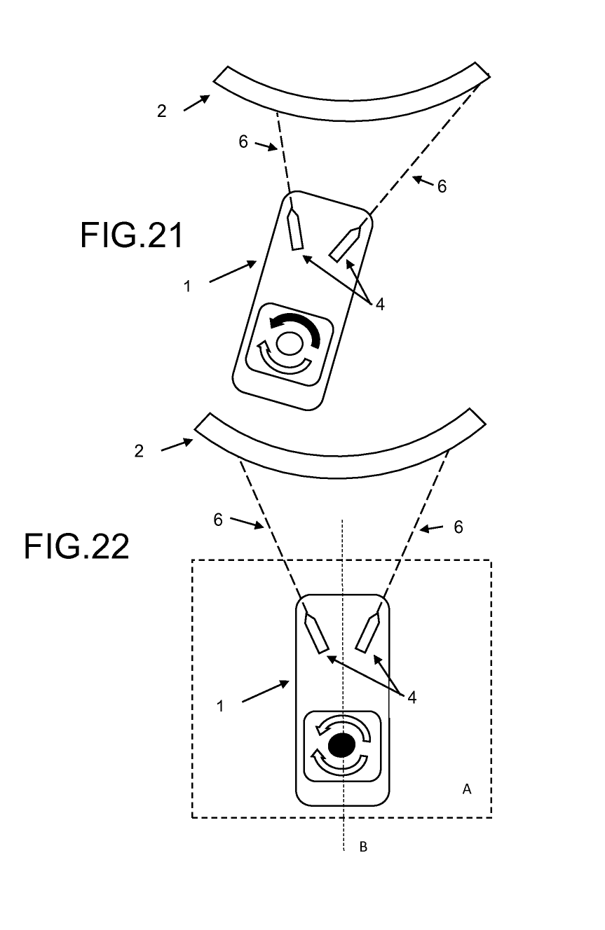

FIG. 21 and FIG. 22 illustrates an embodiment of the measurement apparatus (1) that might be used on a circularly curved surface (2) and/or flat surface. In this embodiment, the measurement apparatus (1) is only capable of determining perpendicularity. The measurement apparatus (2) casts two ancillary distance measurement beams (6) that are on the same plane (A), a plane that is parallel to the top of the measurement apparatus (1), and depart from the measurement apparatus (1) at equal angles with respect to a plane (B—shown on edge). Plane B traverses through the top of the measurement apparatus (1) thus separating the measurement apparatus (1) into two sections, left and right. The measurement apparatus (1) is able to determine perpendicularity in this case by simply comparing the length of the two distances measured by the distance measuring elements (4). If both distances are equal, then the measurement apparatus (1) is perpendicular to the round and/or flat surface (2).

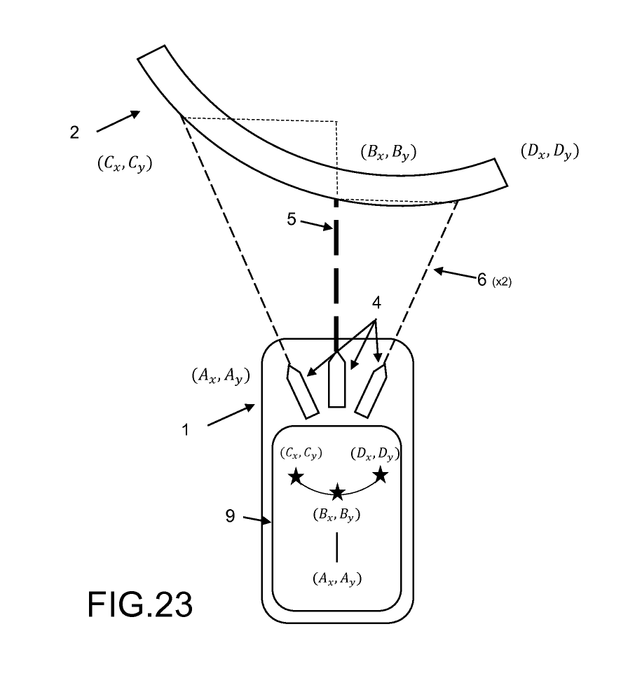

FIG. 23 illustrates an embodiment of the measurement apparatus (1) that can be utilized with curved surfaces (2) that are either convex or concave in two dimensions, and whose curvature can be approximated with a polynomial of the second degree. For this embodiment, utilization of a two dimensional Cartesian coordinate system will be used. This representation of the measurement apparatus (1) shows three distance measuring elements (4) that all lie on the same plane. As discussed in previous illustrations, the angle CAB and the angle DAB are both known, as are the distances AC, AB, and AD. Additionally. Note: point A, the point made by extending all three measurement beams (5 & 6) to a point where they would all cross, would be located near the top and middle of the shown output display (9), however it is labeled to the left. To constrain the coordinate system, point A would be given the (X,Y) coordinate (0,0). Point B would be located on the y axis above point A, and therefore would have the coordinate (0,distance AB). Utilizing right angle triangle formulas, the coordinates of C can be determined by the following formulas:

Cₓ=−length AC*sin(angle CAB)

C_{y}=length AC*cos(angle CAB)

The coordinates of D can be calculated in the same manner, however the X value would not be negative as was the case for C. In this manner, the coordinates for point A, C, B, and D have been determined. The equation of a curve that can be described with a second order polynomial is:

y=a₁*x²+a₂*x+a₃

Wherein a₁, a₂, and a₃, are all constants (and unrelated to point A). Therefore the equation for the curve on the curved surface (2) can be computed mathematically by creating three equations, and solving them simultaneously for the three constants. Once the equation is determined, a normal (a perpendicular line to the curve at a specific point) can be established which can be used to show whether the measurement apparatus (1) is perpendicular to the surface or not. Thus orientation with respect to the curved surface (2) can be established in two dimensions. Additional factors such as curvature at the point of interest can also be determined. Additionally, if the point of interest is a point that is nearly tangent with the curved surface from the perspective of the measurement apparatus, the measurement apparatus might contain circuitry to automatically use one of the ancillary measurement beams as the primary measurement beams, therefore making the primary measurement beam an ancillary measurement beam. Therefore in the measurement apparatus depicted in FIG. 23, the left measurement beam would become the primary measurement beam, and the middle distance measurement beam and the right distance measurement beam would become ancillary measurement beams.

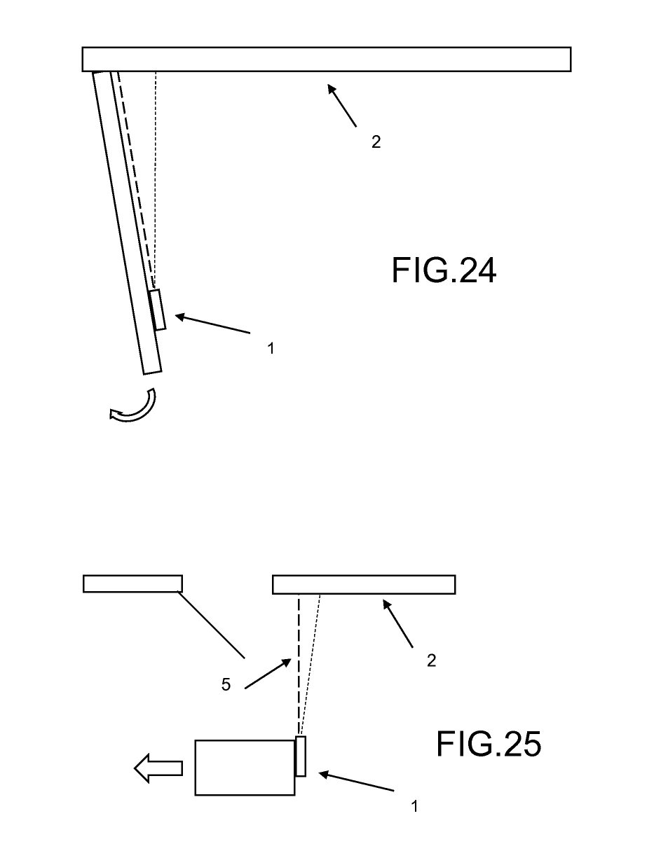

FIG. 24 illustrates a use of an embodiment of the invention in which a builder who is building a deck attached to a ledger board on the house (the flat surface (2)) is attempting to locate a joist so that it is perpendicular to the surface (2). The builder holds the measurement apparatus (1) (and or uses a fastener such as a hook) against the surface of the joist, while pointing the measurement apparatus (1) at the ledger board. The measurement apparatus' output advises the builder to rotate to the left in order to reach a perpendicular state. As the builder continues to rotate, the measurement apparatus (1) continually updates its output until the builder is advised by the measurement apparatus (1) that a perpendicular state has been reached. In this situation, the builder has pointed the measurement apparatus (1) at virtually the same location throughout the movement to perpendicularity.

FIG. 25 illustrates an embodiment of the measurement apparatus (1) in which a user wants to align a desk so that it is directly opposite the open door. In this case, the user may have already established perpendicularity of the desk to the wall (flat surface (1)), but now slides the desk while holding the measurement apparatus (1) flat against the desk, until the measurement apparatus' primary distance measurement beam (5) touches the edge of the door, thus indicating that the desk is in its proper orientation.

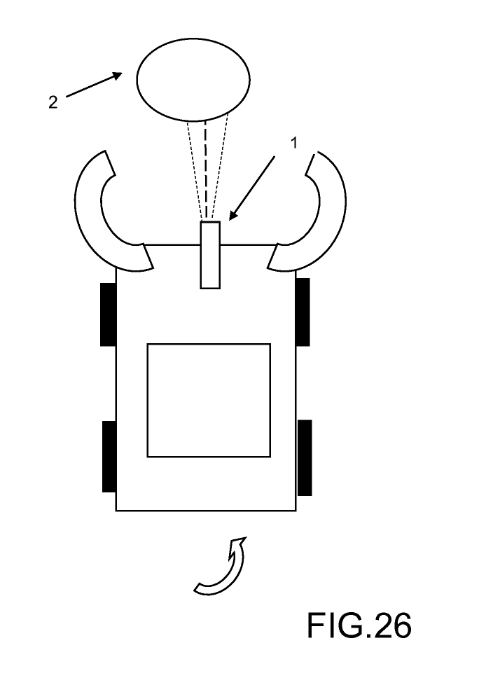

FIG. 26 illustrates an embodiment of the invention that is mounted to a forklift type vehicle that approaches a 55 gallon drum. The measurement apparatus (1) measures the orientation with respect to the rounded surface (2), and advises the driver to rotate to the left in order to align directly with the 55 gallon drum.

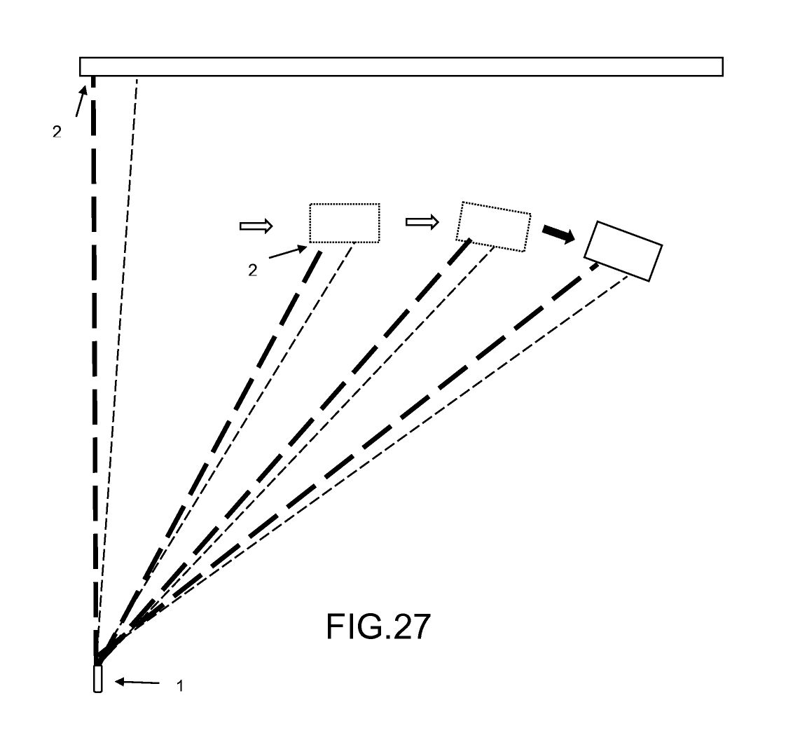

FIG. 27 illustrates an embodiment of the measurement apparatus (1) that uses the memory storage device in the measurement apparatus (1) in order to map a scene. The user of the measurement apparatus (1) picks an out of point location from where to map the scene. The user first captures the orientation to a wall (a flat surface (2)) that serves as a backstage to the scene. Through the interface, the user then enters a designation that one object has been mapped, and now a second object will be mapped. The user then tracks a vehicle (with a flat surface (1)) driving through the area. The memory storage device can then return this information to the processor (and/or supply it to an external computing system), and then recreate the scene graphically as two separate entities. Additional data may need to be added such as the size of the wall and size of the vehicle to make the graphical image complete. Additionally if the time of each orientation measurement were also stored, velocities of the vehicle could be calculated by measuring the change of orientation with respect to the time stamp differences.

The present invention should not be considered limited to the embodiments described above, but rather should be understood to cover all aspects of the invention as fairly set out in the attached claims. Various modification as well as numerous structures to which the present invention may be applicable, will be readily apparent to those skilled in the art to which the present invention is directed upon review of the present disclosure. The claims are intended to cover such modifications.

What is claimed is:

1. A measurement apparatus to locate an out of plane orientation, hereafter referred to as the spot, with respect to a point on a flat surface comprising:
a plurality of distance measuring elements and/or a single distance measuring element capable of measuring distance to at least two unique locations, wherein said distance measuring elements include a distance measuring circuit that determines a distance from the distance measuring element to a surface at which the distance measuring element is pointed, and wherein the orientation of said distance measuring elements can be determined in relation to the spot with or without the assistance of one or more transducers, and wherein said distance measuring elements are situated in a manner that permits collecting a set of distance measurements, wherein a set of distance measurements is two or more distance measurements to unique locations on said flat surface, without necessitating external movement of said measurement apparatus or any of its comprised parts to obtain said set of distance measurements;
a processor, wherein said processor uses any combination of information comprising: distance measurements provided by said distance measuring circuits, physical orientation of components within the measurement apparatus, and/or measurements from said transducers, to mathematically and/or programmatically calculate a measurement result, wherein said measurement result comprises: any combination of measurements and/or relationships between measurements that relate the orientation between the spot, the point, and/or any offset orientations, and wherein said processor generates from said measurement result an output signal encapsulating in whole or in part a representation of said measurement result;
an output device, wherein said output device converts said output signal into an output format that is useable to a user, wherein said user is one or more entities controlling said measurement apparatus and/or receiving the output from said output device;
a power source comprising: any combination of power storage, power generation, or constant power delivery sources;
a connecting circuit, wherein said connecting circuit performs one or more of the functions comprising: relaying signals encapsulating said distance measurements from said distance measuring circuits to said processor, relaying said output signals from said processor to said output device, relaying power from said power source to one or more components of said measurement apparatus;
and a support, wherein said support comprises: any combination of physical case, device, fastener, and/or component that can be used to support and/or orient one or more components of the measurement apparatus.

2. The measurement apparatus of claim 1, wherein sets of measurements are obtained repeatedly allowing said measurement apparatus to continuously track orientation.

3. The measurement apparatus of claim 1, wherein the measurement apparatus utilizes distance measurements to calculate two dimensional orientation information.

4. The measurement apparatus of claim 1, wherein the measurement apparatus utilizes distance measurements to calculate three dimensional orientation information.

5. The measurement apparatus of claim 1, wherein said distance measuring elements generating said distance measurements utilize a coherent light source that illuminates said point on said flat surface at which the measurement apparatus is pointed.

6. The measurement apparatus of claim 1, wherein said distance measuring elements are arranged to cast distance measurement beams that are symmetric in departure angle from a vector extending from the portion of the measurement apparatus that is pointed at the surface, to the surface, and whose angle of departure from said vector is less than 90 degrees in any direction.

7. The measurement apparatus of claim 1, wherein said distance measuring elements are arranged to cast distance measurement beams that are non-symmetric with respect to a vector extending from the portion of the measurement apparatus that is pointed at the surface, to the surface.

8. The measurement apparatus of claim 1, further comprising an interface, said interface allowing said user and/or an external device to interface with said measurement apparatus in order to control one or more inputs, outputs and/or states of said measurement apparatus.

9. The measurement apparatus of claim 1, further comprising control circuitry and related devices if required to automatically control functionality and/or orientation of one or more components of said measurement apparatus,

10. The measurement apparatus of claim 1, wherein said connecting circuits further comprise circuitry to send and/or receive signals wirelessly to include cellular, satellite, and/or other cordless technologies.

11. The measurement apparatus of claim 1, wherein any number of its components are in whole or in part realized using computer related hardware and/or software to include those used in mobile devices.

12. The measurement apparatus of claim 1, wherein said support is a case containing the entire measurement apparatus, and wherein said case includes a handle or grip suitable for use with the human hand.

13. The measurement apparatus of claim 1, wherein said support is designed to either permanently house, and/or temporarily fasten to one or more accessory devices.

14. The measurement apparatus of claim 1, further comprising a memory device, wherein said memory device stores information comprising any combination of distance measurements, measurement results, inputs, outputs, time of measurements, and/or the state of the measurement apparatus and its components, and provides a means to recover said information.

15. A measurement apparatus to locate a two dimensional out of plane orientation, hereafter referred to as the spot, with respect to a point on a curved surface, wherein the surface is curved in two dimensions only, and wherein the curve can be approximated with a polynomial of the second degree comprising:
a plurality of distance measuring elements and/or a single distance measuring element capable of measuring distance to more than one unique location, wherein said distance measuring elements include a distance measuring circuit that determines a distance from the distance measuring element to a surface at which the distance measuring element is pointed, wherein at least three of the distance measuring elements' distance measuring beams are contained within the same plane, and wherein the orientation of said distance measuring elements can be determined in relation to the spot with or without the assistance of one or more transducers, and wherein said distance measuring elements are situated in a manner that permits collecting a set of distance measurements, wherein a set of distance measurements includes three or more distance measurements in the same plane to unique locations on said curved surface, and wherein said distance measurements can be obtained without necessitating external movement of said measurement apparatus or any of its comprised parts to obtain said set of distance measurements;
a processor, wherein said processor uses any combination of information comprising: distance measurements provided by said distance measuring circuits, physical orientation of components within the measurement apparatus, and/or measurements from said transducers, to mathematically and/or programmatically calculate a measurement result, wherein said measurement result comprises: any combination of measurements and/or relationships between measurements that relate the orientation between the spot, the point, and/or any offset orientations, and wherein said processor generates from said measurement result an output signal encapsulating in whole or in part a representation of said measurement result;
an output device, wherein said output device converts said output signal into an output format that is useable to a user, wherein said user is one or more entities controlling said measurement apparatus and/or receiving the output from said output device;
a power source comprising: any combination of power storage, power generation, or constant power delivery sources;
a connecting circuit, wherein said connecting circuit performs one or more of the functions comprising: relaying signals encapsulating said distance measurements from said distance measuring circuits to said processor, relaying said output signals from said processor to said output device, and/or relaying power from said power source to one or more components of said measurement apparatus;
and a support, wherein said support comprises: any combination of physical case, device, fastener, and/or component that can be used to support and or orient one or more components of the measurement apparatus.

16. The measurement apparatus of claim 15, wherein sets of measurements are obtained repeatedly allowing said measurement apparatus to continuously track orientation.

17. The measurement apparatus of claim 15, wherein said distance measuring elements generating said distance measurements utilize a coherent light source that illuminates said point on said curved surface at which the measurement apparatus is pointed.

18. The measurement apparatus of claim 15, wherein said support is designed to either permanently house, and/or temporarily fasten to one or more accessory devices.

19. A measurement apparatus to locate a two dimensional out of plane orientation, hereafter referred to as the spot, with respect to a point on a flat surface and/or curved surface, wherein the surface is curved in two dimensions only, and wherein the curve is circular, comprising:
a plurality of distance measuring elements and/or a single distance measuring element capable of measuring distance to at least two unique locations, wherein said distance measuring elements include a distance measuring circuit that determines a distance from the distance measuring element to a surface at which the distance measuring element is pointed, and wherein the two distance measuring elements' distance measuring beams are non-collinear and contained in the same plane as a vector extending from a point that is midway between the two measurement elements to the point of interest on the surface, and whose orientation is symmetric to said vector, and whose orientation in relation to the spot is known with or without the assistance of one or more transducers, and wherein said distance measuring elements are situated in a manner that permits collecting a set of distance measurements, wherein a set of distance measurements includes two or more distance measurements in the same plane to unique locations on said curved surface, and wherein said distance measurements can be obtained without necessitating external movement of said measurement apparatus or any of its comprised parts to obtain said set of distance measurements;
a processor, wherein said processor uses any combination of information comprising: distance measurements provided by said distance measuring circuits, physical orientation of components within the measurement apparatus, and/or measurements from said transducers, to mathematically and/or programmatically calculate a measurement result, wherein said measurement result comprises: any combination of measurements and/or relationships between measurements that relate the orientation between the spot, the point, and/or any offset orientations, and wherein said processor generates from said measurement result an output signal encapsulating in whole or in part a representation of said measurement result;
an output device, wherein said output device converts said output signal into an output format that is useable to a user, wherein said user is one or more entities controlling said measurement apparatus and/or receiving the output from said output device;
a power source comprising: any combination of power storage, power generation, or constant power delivery sources;
a connecting circuit, wherein said connecting circuit performs one or more of the functions comprising: relaying signals encapsulating said distance measurements from said distance measuring circuits to said processor, relaying said output signals from said processor to said output device, and/or relaying power from said power source to one or more components of said measurement apparatus;
and a support, wherein said support comprises: any combination of physical case, device, fastener, and/or component that can be used to support and or orient one or more components of the measurement apparatus.

20. The measurement apparatus of claim 19, wherein sets of measurements are obtained repeatedly allowing said measurement apparatus to continuously track orientation.
